(19) United States
(12) Patent Application Publication
(10) Pub. No.: US 2012/0312331 A1
(43) Pub. Date: Dec. 13, 2012

(54) METHOD OF PREPROCESSING MAGNESIUM ALLOY FOR ELECTROPLATING

(75) Inventors: Hyung Sop Yoon, Hwaseong (KR); Won Sub Chung, Busan (KR); Jung Hoon Lee, Busan (KR)

(73) Assignees: Pusan National University Industry-University Cooperation Foundation, Pusan (KR); HYUNDAI MOTOR COMPANY, Seoul (KR)

(21) Appl. No.: 13/312,625

(22) Filed: Dec. 6, 2011

(30) Foreign Application Priority Data
Jun. 9, 2011 (KR) 10-2011-0055462

(51) Int. Cl. C23G 1/02; B08B 3/08

(52) U.S. Cl. 134/27; 134/41

(57) ABSTRACT

This invention relates to a method of preprocessing a magnesium alloy for electroplating, including pickling the magnesium alloy with an ethyleneglycol-nitric acid solution.

### CROSS-REFERENCE TO RELATED APPLICATIONS

This application claims under 35 U.S.C. §119(a) priority to Korean Application No. 10-2011-0055462, filed on Jun. 9, 2011, the disclosure of which is incorporated herein by reference in its entirety.

### BACKGROUND OF THE INVENTION

1. Field of the Invention

The present invention relates to a method of preprocessing a magnesium alloy for electroplating.

2. Description of the Related Art

Magnesium, which is lightweight and has high specific strength, is widely used as a structural material for reducing the weight of automobiles. However, because magnesium having high surface oxidation activity is weak in corrosion resistance, its surface treatment is essential upon application to interior or exterior decorative parts.

Most industrial materials or parts often have contaminants or oxide films on their surfaces depending upon the processing method used. Because magnesium alloy has high chemical activity, there is always an oxide film on its surface. Such contaminants and oxide films must be removed upon surface treatment to enhance corrosion resistance and wear resistance of magnesium alloy. Such, surface impurities and oxide films are typically removed using a pickling method.

However, conventional pickling methods of magnesium alloy are disadvantageous because stains may remain on the surface after pickling, and in some cases, the force of adhesion of an electroplating metal may become weakened by pickling. Furthermore, some methods are problematic in that the dissolution rate of the surface is very slow and, thus, pickling effects are not efficiently provided.

### SUMMARY OF THE INVENTION

Accordingly, the present invention has been made keeping in mind the above problems encountered in the related art, and an object of the present invention is to provide a method of preprocessing a magnesium alloy for electroplating. The present methods enable good adhesion and uniform plating upon electroplating of a magnesium alloy, and also effectively removes contaminants and oxide films from the surface of the magnesium alloy.

An aspect of the present invention provides a method of preprocessing a magnesium alloy for electroplating, comprising pickling the magnesium alloy using an ethyleneglycol-nitric acid solution.

In this aspect, the ethyleneglycol-nitric acid solution may comprise a combination of ethyleneglycol and nitric acid, and may further include additional acid and water. In particular, the ethyleneglycol-nitric acid solution of the present invention comprises a combination of ethylene-glycol, nitric acid, phosphoric acid, and water. In an embodiment of the invention, the solution comprises about 75 vol % of ethyleneglycol, about 12 vol % of nitric acid, about 3 vol % of phosphoric acid, and about 10 vol % of water.

In this aspect, pickling the magnesium alloy using the ethyleneglycol-nitric acid solution may be performed at a suitable temperature, such as about 35˜50° C.

In this aspect, pickling the magnesium alloy may be performed by dipping the magnesium alloy in the ethyleneglycol-nitric acid solution for a suitable time to remove surface impurities and oxide films, such as about 2-3 minutes.

In this aspect, the method may further comprise washing the magnesium alloy which was pickled using the ethyleneglycol-nitric acid solution, with a caustic soda solution.

According to embodiments of the present invention, the caustic soda solution may comprise a mixture of caustic soda and water, for example, about 10-20 wt % caustic acid and about 80-90 wt % water, and in some embodiments about 15 wt % of caustic soda and about 85 wt % of water.

Furthermore, washing the magnesium alloy with the caustic soda solution may be performed at a raised temperature, for example about 60˜80° C.

Washing the magnesium alloy with the caustic soda solution may be performed for a suitable time, such as at least about 1 minute.

### BRIEF DESCRIPTION OF THE DRAWING

FIG. 1 is a flowchart showing a process of preprocessing a magnesium alloy for electroplating according to an embodiment of the present invention.

### DESCRIPTION OF SPECIFIC EMBODIMENTS

Reference will now be made in detail to the present preferred embodiments of the present invention, examples of which are illustrated in the accompanying drawings, wherein like reference numerals refer to like elements throughout and the overlapping description therefor is omitted.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

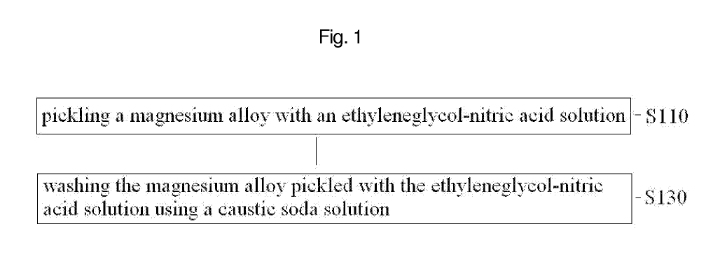

FIG. 1 is a flowchart showing a process of preprocessing a magnesium alloy for electroplating according to an embodiment of the present invention. With reference to FIG. 1, the preprocessing method according to the present embodiment includes pickling a magnesium alloy with an ethyleneglycol-nitric acid solution (S110).

According to the present embodiment, the use of ethyleneglycol as the solvent for pickling can effectively solve the problem of stains being generated on the surface of the magnesium alloy. This is in contrast with conventional pickling method wherein a pickling solution uses water as a solvent. Furthermore, according to the present invention, when the surface of the magnesium alloy is dissolved using the pickling solution containing nitric acid, contaminants formed on the surface of the magnesium alloy can be effectively removed, and the surface of the magnesium alloy may be beneficially provided with a metallic gloss.

In accordance with an exemplary embodiment, the ethyleneglycol-nitric acid pickling solution preferably contains about 75 vol % of ethyleneglycol, about 12 vol % of nitric acid, about 3 vol % of phosphoric acid, and about 10 vol % of water.

It has been found that if the proportions of nitric acid and phosphoric acid in the pickling solution are too high, the dissolution rate of the surface of magnesium alloy is excessively increased, making it difficult to control the pickling time. On the other hand, if the proportions of nitric acid and phosphoric acid are low, the dissolution rate is decreased and the pickling time is lengthened. Also if the proportion of water is increased and the proportion of ethyleneglycol is decreased, stains may remain on the surface of the magnesium alloy. Thus, for example, a pickling solution comprising about 50-80 vol % ethyleneglycol, about 8-15 vol % nitric acid, about 1-5 vol % phosphoric acid, about 5-15 vol % water can provide controllable pickling time, that is not excessive in length, and can provide a magnesium alloy free of stains.

In particular, according to an exemplary embodiment when using as the pickling solution an ethyleneglycol-nitric acid solution comprising about 75 vol % of ethyleneglycol, about 12 vol % of nitric acid, about 3 vol % of phosphoric acid, and about 10 vol % of water, stains do not remain on the surface of the magnesium alloy, and, further, contaminants, oxide films and oxides can be effectively removed from the surface of the magnesium alloy.

According to various embodiments, the magnesium alloy may be pickled by dipping it in an ethyleneglycol-nitric acid solution. In embodiments of the invention, the dipping time of magnesium alloy is in the range of about 2˜3 minutes. It has been found that if the magnesium alloy is dipped for a period of less than about 2 minutes, dissolution on the surface of magnesium alloy may not sufficiently occur to the extent necessary to remove contaminants. In contrast, if the dipping time exceeds 3 minutes, excessive surface dissolution of the magnesium alloy may take place, undesirably changing the dimensions of magnesium alloy part.

Below, the pickling of the magnesium alloy dipped in the ethyleneglycol-nitric acid solution is more specifically described.

When the magnesium alloy is dipped in the ethyleneglycol-nitric acid solution, dissolution of the magnesium alloy occurs on the surface thereof. The contaminants and oxides are removed along with the dissolution of a basic material for a magnesium alloy by means of the phosphoric acid and nitric acid contained in the ethyleneglycol-nitric acid solution. Also, hydrogen gas is generated together with the dissolution of the magnesium alloy, which results in the contaminants and oxides being more efficiently removed from the surface.

After the contaminants and oxide films are removed from the surface of the magnesium alloy, the surface of the magnesium alloy is exposed, meaning that the surface is in a state of considerable activation, and may be easily oxidized and contaminated. As such, the surface of the magnesium alloy having been dipped in the ethyleneglycol-nitric acid solution, is enclosed within ethyleneglycol, which thereby prevents excessive oxidation and the production of stains.

According to the present embodiment, the pickling of magnesium alloy is performed at a suitable temperature, particularly about 35˜50° C. If the pickling of magnesium alloy is carried out at too low or high a temperature, such as lower than about 35° C. or higher than about 50° C., the dissolution reaction caused by the ethyleneglycol-nitric acid solution may not occur vigorously enough.

With reference to FIG. 1, the preprocessing method according to the present invention may further comprise washing the magnesium alloy pickled with the ethyleneglycol-nitric acid solution using a caustic soda solution (S130).

Although ethyleneglycol that remains on the surface of the pickled magnesium alloy suppresses the oxidation of magnesium alloy, it acts as a contaminant in a subsequent electroplating process. Hence, ethyleneglycol that remains on the surface of the magnesium alloy should be completely removed before electroplating.

The caustic soda contained in the caustic soda solution functions to easily dissolve and remove ethyleneglycol that remains on the surface of the pickled magnesium alloy. Furthermore, the caustic soda solution is strongly alkaline, thus effectively neutralizing the acidic material that remains on the surface of the magnesium alloy.

The caustic soda solution may include a suitable ration of caustic soda to water, such as about 15 wt % of caustic soda and about 85 wt % of water, but the present invention is not limited thereto. If the concentration of caustic soda is low, a period of time required to remove ethyleneglycol that remains on the surface of the magnesium alloy may increase. For this reason, the concentration of caustic soda is preferably at least about 15 wt % or more.

Washing using the caustic soda solution is preferably performed at a heightened temperature, such as about 60˜80° C. In such a heightened temperature range, the neutralization reaction using the caustic soda solution may be more vigorous.

Washing using the caustic soda solution is preferably performed for a suitable time, such as at least about 1 minute. If the washing using the caustic soda solution is carried out for less than about 1 minute, ethyleneglycol that remains on the surface of the magnesium alloy may not be sufficiently removed, and the neutralization reaction may not be sufficiently carried out.

As described hereinbefore, the present invention provides a method of preprocessing a magnesium alloy for electroplating. According to the present invention, an ethyleneglycol-nitric acid solution is used as a pickling solution. By using the pickling solution and methods of the present invention, the problem of stains being formed on the surface of pickled magnesium alloy is solved, and contaminants can be effectively removed from the surface of magnesium alloy.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preprocessing a magnesium alloy for electroplating, comprising:
pickling the magnesium alloy using an ethyleneglycol-nitric acid solution.

2. The method of claim 1, wherein the ethyleneglycol-nitric acid solution comprises ethyleneglycol, nitric acid, phosphoric acid, and water.

3. The method of claim 2, wherein the ethyleneglycol-nitric acid solution comprises about 70-80 vol % ethyleneglycol, about 8-15 vol % nitric acid, about 1-5 vol % phosphoric acid, and about 5-15 vol % water.

4. The method of claim 2, wherein the ethyleneglycol-nitric acid solution comprises about 75 vol % of ethyleneglycol, about 12 vol % of nitric acid, about 3 vol % of phosphoric acid, and about 10 vol % of water.

5. The method of claim 1, wherein the pickling the magnesium alloy using the ethyleneglycol-nitric acid solution is performed at about 35˜50° C.

6. The method of claim 1, wherein the pickling the magnesium alloy is performed by dipping the magnesium alloy in the ethyleneglycol-nitric acid solution for about 2˜3 minutes.

7. The method of claim 1, further comprising, after pickling the magnesium alloy using the ethyleneglycol-nitric acid solution, washing with a caustic soda solution.

8. The method of claim 7, wherein the caustic soda solution comprises about 10-20 wt % caustic acid and about 80-90 wt % water.

9. The method of claim 7, wherein the caustic soda solution comprises about 15 wt % of caustic soda and about 85 wt % of water.

10. The method of claim 7, wherein the washing the magnesium alloy with the caustic soda solution is performed at about 60˜80° C.

11. The method of claim 7, wherein the washing the magnesium alloy with the caustic soda solution is performed for at least about 1 minute.
